(19) United States
(12) Patent Application Publication
(10) Pub. No.: US 2014/0262577 A1
(43) Pub. Date: Sep. 18, 2014

(54) TOWING SYSTEM

(71) Applicant: William M. Ambrisco, Woodside, CA (US)

(72) Inventor: William M. Ambrisco, Woodside, CA (US)

(21) Appl. No.: 14/205,193

(22) Filed: Mar. 11, 2014

Related U.S. Application Data
(60) Provisional application No. 61/851,666, filed on Mar. 12, 2013.

(51) Int. Cl. B62D 49/00; B60D 1/14

(52) U.S. Cl. CPC B62D 49/00; B60D 1/14
USPC 180/167; 180/54.1; 180/65.8

(57) ABSTRACT

A tow control remotely controls a connected towing vehicle by generating and transmitting a signal that controls the propulsion of the towing vehicle. The towing vehicle is controllable to generate propulsion for the tow control, a towed vehicle, and an operator. A flexible tow line joins the tow control to the towing vehicle. The operator, while holding the tow control and mounting the towed vehicle, can maintain independent movement relative to the towing vehicle because of the flexible nature of the tow line and the distance between the towing vehicle and tow control. The towing vehicle includes a receiver that remotely receives a signal from a transmitter on the tow control. The receiver relays the signal to a processor that regulates a steering portion, motor, and brake mechanism on the towing vehicle. A control portion on the tow control generates the signal for operation.

### CROSS-REFERENCE TO RELATED APPLICATIONS

The present Utility patent application claims priority benefit of the U.S. provisional application for patent Ser. No. 61/851,666 entitled “Powered tow vehicle with a towline and a handle with controls”, filed on Mar. 12, 2013 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a towing system. More particularly, the invention relates to a towing system that enables a towed vehicle to remotely control a towing vehicle and also maintain independent lateral movement and velocity from the towing vehicle.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that towing is the process of coupling a rear object to a mobile lead object so that the rear object can be pulled along behind the lead object.

Typically, the lead object is a vehicle, like a truck or other motorized land vehicle. But anything from waterborne vessels to tractors to animals to people can tow a rear object behind the lead object. The rear object can include a machine, vehicle, or person that is stuck or does not have a means for propulsion. The coupling may consist of a chain, rope, bar, integrated platform, or some other means of keeping the two objects together while in motion.

Often, an individual can be pulled behind a vehicle over a surface. This pulling maneuver requires sufficient area on a smooth stretch of land, a vehicle for an operator to mount, and a tow rope. In addition, the operator must have adequate upper and lower body strength, muscular endurance, and good balance.

It is known that, a remote control device is used for operating the device wirelessly from a short line-of-sight distance. The remote control device emits a signal from a specialized transmitter, such as infrared light or radio signal, towards a receiver. The remote control device can be used to operate a vehicle performing numerous maneuvers.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B, and 1C illustrate various views of an exemplary towing system, where FIG. 1A illustrates a detailed perspective view, FIG. 1B illustrates an elevated side view, and FIG. 1C illustrates a top view, in accordance with an embodiment of the present invention;

FIGS. 2A and 2B illustrate an exemplary towing vehicle having an exemplary electrical motor, where FIG. 2A illustrates an elevated side view, and FIG. 2B illustrates a top view, in accordance with an embodiment of the present invention;

FIGS. 3A and 3B illustrate an exemplary towing vehicle having an exemplary gas motor, where FIG. 3A illustrates an elevated side view, and FIG. 3B illustrates a top view, in accordance with an embodiment of the present invention;

FIG. 4 illustrates a detailed perspective view of an exemplary steering portion, in accordance with an embodiment of the present invention;

FIG. 5 illustrates a detailed perspective view of an exemplary tow control, in accordance with an embodiment of the present invention;

FIG. 6 illustrates a detailed perspective view of an exemplary towing system configured for operating on snow, in accordance with an embodiment of the present invention; and

FIG. 7 illustrates a block diagram depicting an exemplary client/server system which may be used by an exemplary web-enabled/networked embodiment, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The present invention will now be described in detail with reference to embodiments thereof as illustrated in the accompanying drawings.

There are various types of a towing system that may be provided by preferred embodiments of the present invention. In one embodiment of the present invention, the towing system may include a tow control that remotely controls a connected towing vehicle. The tow control may generate and transmit a signal that operates and controls the propulsion of the towing vehicle. The towing vehicle may be controlled to generate propulsion for the tow control and any other joined components, such as a towed vehicle and an operator.

In some embodiments, a flexible tow line may join the tow control to the towing vehicle. The tow control can maintain independent movement relative to the towing vehicle because of the flexible nature of the tow line and the distance between them. In essence, the towing vehicle provides the propulsion for the tow control, while the tow control regulates the steering, velocity, and various other operating manipulations separately from the towing vehicle. The present invention may be efficacious for performing towing operations on a terrain surface, such as earth, snow, ice, sand, and muck.

In some embodiments, the towing system may include a towing vehicle configured to generate propulsion. The towing vehicle may include a motorized vehicle having a motor, a braking mechanism, a steering portion, and a steering actuator. The towing vehicle may include a receiver for receiving a signal. The receiver may relay the signal to a processor on the towing vehicle for processing and for regulating the motor, and/or the braking mechanism, and/or the steering portion, and/or the steering actuator.

In some embodiments, the towing system may further include a tow control that at least partially controls the towing vehicle. The tow control joins with the towing vehicle through a flexible tow line that extends there between. The tow control is configured to receive at least partial propulsion from the towing vehicle through a pulling force. The tow control may include a transmitter configured to emit a signal to the receiver. The signal may transmit remotely or through a signal communication line that aligns along a longitudinal axis of the tow line. A control portion provides a plurality of switches that generate the signal. The signal emitted by the tow control is configured to at least partially control the towing vehicle, and may include, without limitation, a radio frequency and infrared light. In this manner, the tow control maintains a distance from the towing vehicle, yet remains joined through the tow line. The flexible nature of the tow line and the proximal distance enable independent maneuverability by the tow control and any components joined thereto.

In some embodiments, the components that may join and operate the tow control may include an operator and a towed vehicle. The operator may grip and manipulate the tow control with a handle that integrates into the tow control. The operator may mount a towed vehicle while gripping the handle. The towed vehicle may be configured to support the operator and receive propulsion from the towing vehicle. The operator may at least partially control propulsion of the towing vehicle by manipulating the control portion. Additionally, the operator may at least partially control steering of the towed vehicle independently of the towing vehicle. The flexible nature of the tow line and the distance between the tow control and the towing vehicle provide sufficient spacing to enable the operator to steer and maneuver independently of the direction and velocity of the towing vehicle.

FIGS. 1A, 1B, and 1C illustrate various views of an exemplary towing system, where FIG. 1A illustrates a detailed perspective view, FIG. 1B illustrates an elevated side view, and FIG. 1C illustrates a top view, in accordance with an embodiment of the present invention. In the present invention, a towing system 100 may enable an operator to remotely control a towing vehicle 102 from a remote tow control 104. A tow line 106 may join the towing system with the tow control. In one embodiment, the tow line includes a flexible tensile load element, approximately 15 to 30 feet in length. The operator may mount on a towed vehicle (not shown) while controlling the towing vehicle with the tow control. The tow line may include, without limitation, a bungee cord, a chain, a rope, and a nylon cable. While being towed, the operator may be propelled by the towing vehicle. The operator may also maneuver and steer independently from the towing vehicle due to the flexible nature of the tow line and the distance from the towing vehicle.

In some embodiments, the system may include a tow control that remotely controls a connected towing vehicle. The tow control may generate and transmit a signal that operates and controls the propulsion of the towing vehicle. The signal may transmit remotely. However, in some embodiments, the signal may transmit through a signal communication line that runs along the tow line. In many practical applications other ways may include RF and IR light. The towing vehicle may be controlled to generate propulsion for the tow control and any other joined components, such as a towed vehicle and an operator. A flexible tow line may join the tow control to the towing vehicle. The tow control can maintain independent movement relative to the towing vehicle because of the flexible nature of the tow line. In essence, the towing vehicle provides the propulsion for the tow control, while the tow control regulates the steering and various other operating manipulations separately from the towing vehicle. In one embodiment, the towing system may be operable on land, including, without limitation, a roadway, an off-road path, snow, and ice.

In some embodiments, the towing system may include a towing vehicle configured to generate propulsion. The towing vehicle may include a frame 116 that forms a rigid structure for supporting other components of the towing vehicle and anchoring to the tow control through the tow line. The frame may be constructed from various materials, including, without limitation, steel, aluminum, metal alloys, a rigid polymer, fiberglass, and wood. The towing vehicle may be motorized, having a motor for propulsion of the towing vehicle. A drive mechanism 114 may operatively join with the motor to rotate a rear axle for generating propulsion. At least one ballast 110 may join the frame and operatively connect to the steering portion to help improve traction. Each ballast may position in proximity to a wheel. Those skilled in the art will recognize that the enhanced traction may be useful when towing a heavy load. By way of example, and not limitation, an airborne vehicle, such as a multi-rotor flying device, may provide the motive force.

In some embodiments, the tow vehicle may further include a brake mechanism 124 for stopping the towing vehicle. The brake mechanism may include a standard disc brake, brake pads, and a rotor that utilizes friction to restrict movement of a rear wheel. The towing vehicle may further include a steering portion 106 for enabling directional control of the towing vehicle. The steering portion may include a front wheel that is controlled by a steering actuator 108, such as a small electrical motor that swivels while in operational connection with the steering portion. The front wheel may include a castor wheel that controllably swivels in the direction of movement, in response to the steering actuator. In some embodiments, the towing vehicle may include a receiver for receiving a signal from the tow control. The receiver may relay the signal to a processor for processing and for regulating the motor, and/or the braking mechanism, and/or the steering portion, and/or the steering actuator.

In some embodiments, the towing system may further include a tow control that at least partially controls the towing vehicle. The tow control joins with the towing vehicle through a flexible tow line that extends there between. The tow control may include a tow line mount 122 for fastening to one end of the tow line. The tow line aperture may include, without limitation, a ring, a slot, a rod, and a bracket. The tow control may include a handle 120 that provides a grip for the operator. In this manner, the operator may grasp the tow control while simultaneously controlling the towing vehicle through the tow control. In some embodiments, the operator, while grasping the tow control, is configured to receive at least partial propulsion from the towing vehicle through a pulling force. In some practical applications, without limitation, the tow control may attach to the operators body so as to allow at least a portion of the forces generated upon the operator to be supported by the operators hips, thereby relieving some loading of the shoulders and back musculature. It is contemplated that such an arrangement would necessitate a quick-release safety mechanism should the operator stumble, fall or otherwise need to quickly disconnect from the tow control and towing vehicle.

The tow control may include a transmitter configured to emit a signal to the receiver. The signal may transmit remotely or through a signal communication line that aligns along a longitudinal axis of the tow line. A control portion 118 provides a plurality of switches that generate the signal. The signal emitted by the tow control is configured to at least partially control the towing vehicle, and may include, without limitation, a radio frequency and infrared light. In this manner, the tow control maintains a distance from the towing vehicle, yet remains joined through the tow line. The flexible nature of the tow line and the proximal distance enable independent maneuverability by the tow control and any components joined thereto.

In some embodiments, the components that join and operate the tow control may include an operator and a towed vehicle. The operator may include a rider balancing on the towed vehicle. The operator may grip and manipulate the tow control with a handle that integrates into the tow control. The operator may mount a towed vehicle while gripping the handle. The operator may grasp the tow control to be towed forward, while performing maneuvers to steer independently of the towing vehicle. For example, the operator may increase the velocity of the towing vehicle though the tow control, while leaning to a left side of the towed vehicle to turn left. The towing vehicle may remain oriented in a straight trajectory during the operator's turn to the left. For example, without limitation, the operator may perform carving sweeping turns and catch air off of ramps without requiring a mountain or hill, as the flexibility provided through independent steering enables such maneuvers. In addition, there is no need for a tow vehicle driver and spotter, as are required for water skiing; thus allowing autonomous on-land use by an operator.

In some embodiments, the towed vehicle may include, without limitation, a skateboard, roller skates, a board, skis, and a sled. The towed vehicle may be configured to support the operator and receive propulsion from the towing vehicle. The operator may at least partially control propulsion of the towing vehicle by manipulating the control portion. Additionally, the operator may at least partially control steering of the towed vehicle independently of the towing vehicle. The flexible nature of the tow line and the distance between the tow control and the towing vehicle provide sufficient spacing to enable the operator to steer and maneuver independently of the direction and velocity of the towing vehicle.

FIGS. 2A and 2B illustrate an exemplary towing vehicle having an exemplary electrical motor, where FIG. 2A illustrates an elevated side view, and FIG. 2B illustrates a top view, in accordance with an embodiment of the present invention. In the present invention, the towing vehicle may be motorized, having an electrical motor 200 for propulsion of the towing vehicle. The electrical motor may be powered through a power source 202, including, without limitation, a battery, a solar panel, and an external power source. A recharging device may recharge the power source. In some embodiments, a modulator, a sprocket, distributor, pulley, and chain may be utilized with the electrical motor for efficient operation and generating sufficient towing torque.

FIGS. 3A and 3B illustrate an exemplary towing vehicle having an exemplary gas motor, where FIG. 3A illustrates an elevated side view, and FIG. 3B illustrates a top view, in accordance with an embodiment of the present invention. In the present invention, the towing vehicle may be motorized, having a gas motor 300 for propulsion of the towing vehicle. The gas motor may include a two or four cylinder gas combustion engine. A gas tank may fuel the gas motor. However in other embodiments, natural gas may be utilized, in which case a natural gas tank and a protective casing may be required for safety. In some embodiments, a torque convertor 302 transfers power generated by the gas motor to the drive mechanism. The torque converter may include a converter known in the art. Since the towing vehicle is unmanned, and therefore operates through a manual gear shifting mechanism, the torque converter is utilized in place of a clutch. It is contemplated that, without limitation, another possible fuel might be hydrogen.

FIG. 4 illustrates a detailed perspective view of an exemplary steering portion, in accordance with an embodiment of the present invention. In the present invention, the steering portion may include a wheel held in place by a steerable fork. The steering actuator may form a mechanical linkage with the steerable fork to direct the orientation of the wheel. The steering portion may orient the towing vehicle in a direction that is regulated by the tow control through the steering actuator. However, the tow control, while joined with the operator and the towed vehicle, may follow an independent trajectory from the tow vehicle. The operator is then able to manipulate the towed vehicle to deviate from the direction of the steering portion. The flexible nature of the tow line and the distance between the tow control and the towing vehicle provide sufficient spacing to enable the operator to steer and maneuver independently of the direction and velocity of the towing vehicle. In some embodiments, the tow line may include a spool for reeling in and paying out the tow line to further provide control over the independent maneuverability by the operator. In some practical applications, without limitation, methods of steering actuation may include using a lead-screw and captured follower nut as shown, bell cranks and link arms, pulleys and belts or sprockets and chains, for connecting an actuator output directly the steerable fork.

FIG. 5 illustrates a detailed perspective view of an exemplary tow control, in accordance with an embodiment of the present invention. In the present invention, the tow control transmits the signal to the receiver on the towing vehicle through a transmitter 500. The transmitter may include an antenna 502 to enhance the signal, especially during turbulent movement and in environments where the signal is not strong. The transmitter may include a remote control configuration, such as a multi-channel radio transmitter, or an infrared light emitting diode. The receiver may receive the signal and pass the signal through circuitry for final processing to the processor. Those skilled in the art will recognize that the multi-channel configuration may enable modulating the carrier with signals of different frequency. After the receiver demodulates the received signal, it applies the appropriate frequency filters to separate the respective signals. However in other embodiments, a single channel transmitter may be utilized. In some embodiments, the signal may travel through a signal communication line that runs along a longitudinal axis of the tow line. The signal communication line may include, without limitation, a wire, a multi-wire cable, and a fiber optic cable.

In some embodiments, the handle may include a rigid rod that integrates into the tow control. The handle provides a surface for the operator to grip while being towed by the towing vehicle. The operator may mount a towed vehicle while gripping the handle. The operator may at least partially control propulsion of the towing vehicle by manipulating the control portion on the tow control. The control portion may include a steering switch 504 that operatively joins with the steering actuator. The control portion may further include a throttle/brake switch 506 that operatively joins with the motor and the brake mechanism. Operation of the control portion can be accomplished through various means, including, without limitation, mechanical cables, electrical cables, optical cables, hydraulic lines, pneumatic lines. In some embodiments, the control portion of the tow control may be controlled wirelessly through various means, including, without limitation, wirelessly, radio, Bluetooth, or infrared light.

FIG. 6 illustrates a detailed perspective view of an exemplary towing system configured for operating on snow, in accordance with an embodiment of the present invention. In the present invention, the towing system may operate on eclectic terrains and solid surfaces. In one embodiment, a snow towing system 600 enables towing in a snow or ice surface. For this towing arrangement, a snow steering portion 602 replaces the wheels of the aforementioned steering portion. The snow steering portion may include a smooth underside or a separate body supported by two or more smooth, relatively narrow, longitudinal runners that travels by sliding across a snow or ice surface. Due to the slippery conditions that may occur in the snow, the towing vehicle may include n operator stand 604 for enabling a leg to rest on. Similar to the snow towing system, a sand towing system may include treads, and a swamp towing system may include oversized, buoyant tires. In any case, the principles of controlling the towing vehicle propulsion while independently steering are maintained. It is contemplated that, without limitation, various system embodiments of the present invention may be configured to be used underwater as well as on land.

In one alternative embodiment, the control portion may be controlled form an external source, independent of the tow control and the operator. In another alternative embodiment, the towing vehicle includes a forward facing camera and the tow control includes a display screen to show an image captured by the camera. In yet another alternative embodiment, the towed vehicle is configured to elevate or glide after sufficient velocity has been attained by the towing vehicle. In this manner, the operator may not only steer independently of the towing vehicle in a lateral direction, but also in a vertical orientation.

FIG. 7 illustrates a block diagram depicting an exemplary client/server system which may be used by an exemplary web-enabled/networked embodiment of the present invention. In the present invention, a communication system 700 includes a multiplicity of clients with a sampling of clients denoted as a client 702 and a client 704, a multiplicity of local networks with a sampling of networks denoted as a local network 706 and a local network 708, a global network 710 and a multiplicity of servers with a sampling of servers denoted as a server 712 and a server 714.

Client 702 may communicate bi-directionally with local network 706 via a communication channel 716. Client 704 may communicate bi-directionally with local network 708 via a communication channel 718. Local network 706 may communicate bi-directionally with global network 710 via a communication channel 720. Local network 708 may communicate bi-directionally with global network 710 via a communication channel 722. Global network 710 may communicate bi-directionally with server 712 and server 714 via a communication channel 724. Server 712 and server 714 may communicate bi-directionally with each other via communication channel 724. Furthermore, clients 702, 704, local networks 706, 708, global network 710 and servers 712, 714 may each communicate bi-directionally with each other.

In one embodiment, global network 710 may operate as the Internet. It will be understood by those skilled in the art that communication system 700 may take many different forms. Non-limiting examples of forms for communication system 700 include local area networks (LANs), wide area networks (WANs), wired telephone networks, wireless networks, or any other network supporting data communication between respective entities.

Clients 702 and 704 may take many different forms. Non-limiting examples of clients 702 and 704 include personal computers, personal digital assistants (PDAs), cellular phones and smartphones.

Client 702 includes a CPU 726, a pointing device 728, a keyboard 730, a microphone 732, a printer 734, a memory 736, a mass memory storage 738, a GUI 740, a video camera 742, an input/output interface 744 and a network interface 746.

CPU 726, pointing device 728, keyboard 730, microphone 732, printer 734, memory 736, mass memory storage 738, GUI 740, video camera 742, input/output interface 744 and network interface 746 may communicate in a unidirectional manner or a bi-directional manner with each other via a communication channel 748. Communication channel 748 may be configured as a single communication channel or a multiplicity of communication channels.

CPU 726 may be comprised of a single processor or multiple processors. CPU 726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 736 is used typically to transfer data and instructions to CPU 726 in a bi-directional manner. Memory 736, as discussed previously, may include any suitable computer-readable media, intended for data storage, such as those described above excluding any wired or wireless transmissions unless specifically noted. Mass memory storage 738 may also be coupled bi-directionally to CPU 726 and provides additional data storage capacity and may include any of the computer-readable media described above. Mass memory storage 738 may be used to store programs, data and the like and is typically a secondary storage medium such as a hard disk. It will be appreciated that the information retained within mass memory storage 738, may, in appropriate cases, be incorporated in standard fashion as part of memory 736 as virtual memory.

CPU 726 may be coupled to GUI 740. GUI 740 enables a user to view the operation of computer operating system and software. CPU 726 may be coupled to pointing device 728. Non-limiting examples of pointing device 728 include computer mouse, trackball and touchpad. Pointing device 728 enables a user with the capability to maneuver a computer cursor about the viewing area of GUI 740 and select areas or features in the viewing area of GUI 740. CPU 726 may be coupled to keyboard 730. Keyboard 730 enables a user with the capability to input alphanumeric textual information to CPU 726. CPU 726 may be coupled to microphone 732. Microphone 732 enables audio produced by a user to be recorded, processed and communicated by CPU 726. CPU 726 may be connected to printer 734. Printer 734 enables a user with the capability to print information to a sheet of paper. CPU 726 may be connected to video camera 742. Video camera 742 enables video produced or captured by user to be recorded, processed and communicated by CPU 726.

CPU 726 may also be coupled to input/output interface 744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 726 optionally may be coupled to network interface 746 which enables communication with an external device such as a database or a computer or telecommunications or internet network using an external connection shown generally as communication channel 716, which may be implemented as a hardwired or wireless communications link using suitable conventional technologies. With such a connection, CPU 726 might receive information from the network, or might output information to a network in the course of performing the method steps described in the teachings of the present invention.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a towing vehicle that tows a controlling device and a towed vehicle, and is controlled remotely according to the present invention will be apparent to those skilled in the art. Various aspects of the invention have been described above by way of illustration, and the specific embodiments disclosed are not intended to limit the invention to the particular forms disclosed. The particular implementation of the towing vehicle that tows a controlling device and a towed vehicle, and is controlled remotely may vary depending upon the particular context or application. By way of example, and not limitation, the towing vehicle that tows a controlling device and a towed vehicle, and is controlled remotely described in the foregoing were principally directed to a motorized vehicle that tows a controller and a towed vehicle and is controlled by the controller implementations; however, similar techniques may instead be applied to skiing operations with a motorized vehicle pulling a skier holding the tow control integrated into the ski handles, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a towing vehicle configured to generate propulsion, said towing vehicle comprising a receiver;
a tow control comprising a transmitter configured to emit a signal to said receiver, said signal configured to at least partially control said towing vehicle, said tow control configured to receive at least partial propulsion from said towing vehicle; and
a tow line configured to join said towing vehicle to said tow control, said tow line comprising sufficient flexibility and length for enabling said tow control to at least partially maneuver independently of said towing vehicle.

2. The system of claim 1, in which said system is configured to operate on land.

3. The system of claim 2, in which said towing vehicle comprises a frame configured to form a rigid support, said towing vehicle further comprising at least one ballast, said at least one ballast configure to enhance traction control during operation of said towing vehicle.

4. The system of claim 3, in which said towing vehicle comprises a motor, said motor comprising a gas motor or an electrical motor.

5. The system of claim 4, in which said motor is configured to operatively join said receiver.

6. The system of claim 5, in which said towing vehicle comprises a steering portion configured to steer said towing vehicle, said steering portion comprising a wheel.

7. The system of claim 6, in which said steering portion comprises a steering actuator, said steering actuator configured to operatively join said receiver.

8. The system of claim 7, in which said towing vehicle comprises a brake mechanism.

9. The system of claim 8, in which said brake mechanism is configured to operatively join said receiver.

10. The system of claim 9, in which said receiver comprises a radio frequency receiver.

11. The system of claim 10, in which said receiver is configured to relay said signal to a processor on said towing vehicle.

12. The system of claim 11, in which said processor is configured to process said signal and regulate said motor, and/or said steering actuator, and/or said brake mechanism.

13. The system of claim 12, in which said tow control comprises a handle configured to provide a grip.

14. The system of claim 13, in which said tow control comprises a control portion configured to generate said signal.

15. The system of claim 14, in which said control portion comprises a plurality of switches, said plurality of switches comprising a steering switch and a throttle/brake switch.

16. The system of claim 15, in which said transmitter comprises a multi-channel radio transmitter, said transmitter further comprising an antenna.

17. The system of claim 16, in which said tow line comprises a flexible cable.

18. The system of claim 17, in which said system comprises a towed vehicle configured to be towed by said towing vehicle, said towed vehicle further configured to receive an operator, said operator configured to join with said tow control, said operator further configured to at least partially control propulsion of said towing vehicle with said tow control, said operator further configured to at least partially control steering of said towed vehicle independently of said towing vehicle.

19. A system comprising:
means for joining a towing vehicle with a tow control through a tow line;
means for emitting a signal from a transmitter on said tow control;
means for receiving said signal with a receiver on said towing vehicle;
means for relaying said signal to a processor;
means for regulating a motor, and/or a steering actuator, and/or a brake mechanism on said towing vehicle;
means for towing said tow control; and
means for at least partially controlling steering of said towed vehicle independently of said towing vehicle.

20. A system consisting of:
a towing vehicle configured to generate propulsion, said towing vehicle comprising a motor, and/or a steering actuator, and/or a brake mechanism, said towing vehicle comprising a receiver, said receiver comprising a radio frequency receiver, said receiver configured to relay said signal to a processor on said towing vehicle;
a tow control comprising a transmitter configured to emit a signal to said receiver, said transmitter comprising a multi-channel radio transmitter, said transmitter further comprising an antenna said signal configured to at least partially control said towing vehicle, said tow control configured to receive at least partial propulsion from said towing vehicle, said tow control comprising a handle configured to provide a grip, said tow control further comprising a control portion configured to generate said signal, said control portion comprising a plurality of switches, said plurality of switches comprising a steering switch and a throttle/brake switch;
a tow line configured to join said towing vehicle to said tow control, said tow line comprising sufficient flexibility and length for enabling said tow control to at least partially maneuver independently of said towing vehicle, said tow line comprising a flexible cable;
a towed vehicle configured to be towed by said towing vehicle, said towed vehicle comprising a skateboard; and
an operator configured to mount said towed vehicle and join with said tow control, said operator configured to at least partially control steering of said towed vehicle independently of said towing vehicle.
